(19) United States
(12) Patent Application Publication
(10) Pub. No.: US 2006/0103767 A1
(43) Pub. Date: May 18, 2006

(54) Network device having IR remote control and audio and video signal transmitting capabilities

(75) Inventors: Jyh-Ming Kuo, Kaohsiung (TW); Tai-An Lu, Kaohsiung (TW); Tao-Cheng Chen, Kaohsiung (TW)

Correspondence Address: NIKOLAI & MERSEREAU, P.A., 900 SECOND AVENUE SOUTH, SUITE 820, MINNEAPOLIS, MN, 55402, US

(73) Assignee: MICROLINKS TECHNOLOGY CORP., Kaohsiung (TW)

(21) Appl. No.: 10/987,537

(22) Filed: Nov. 12, 2004

(51) Int. Cl. G06F 3/00; G06F 13/00; H04N 7/173; H04N 5/445

(52) U.S. Cl. 348/734; 725/37; 725/110; 725/109

(57) ABSTRACT

A network device for A/V products having IR remote control has first and second network transmitters connected to a common network media to transmit network packages to each other. The first network transmitter is connected to one A/V terminal and converts IR signals to command packages. The second network transmitter is connected to at least one A/V player and converts command packages to IR signals corresponding to the A/V player. When an IR signal from a IR remote control is sent to the first network transmitter, the second network transmitter will receive the command packages from the first network transmitter and output the same IR signal to an A/V player to control functions of the A/V player. Since network media are being built into houses as the advent of digital home era, the present invention easily integrates all A/V products to make remote control more convenient.

### BACKGROUND OF THE INVENTION

1. Field of the Invention

The present invention relates to a network device having infrared (IR) remote control and audio and video signal transmitting capabilities and more particularly to a network device to connect to audio and video (A/V) products with IR remote control and to receive, convert and output an IR signal from the IR remote control of the A/V products to control the A/V product through a network and IR remote control.

2. Description of Related Art

One of the cheapest ways to control a device remotely within a visible range is via infrared (IR) light. Almost all modem audio and video (A/V) equipment can be controlled remotely with IR remote controllers and has the required IR transmission, reception and control components imbedded in the equipment.

Infrared is invisible light contiguous to the red end of the visible spectrum that comprises electromagnetic radiation of wavelengths from 800 nm to 1 mm. IR was chosen for remote control because it is invisible to the human eye and operates at such low power levels that the frequency does not interfere with sensitive modem electronic equipment. Another reason is because IR LEDs are quite easy to make, and therefore can be very cheap. Since virtually everything in the environment has an infrared signature, some precautions have to be taken to guarantee that a desired IR message gets to the receiver without errors. Modulation is an answer to make the signal stand out above the noise. With modulation, the IR light source blinks at a particular frequency. The IR receiver will be tuned to that frequency, so it can ignore everything else. Using variable modulation, a single IR remote control can control different A/V products.

The IR remote control provides a wireless control capability, but the IR remote control has some drawbacks. For example, IR remote controls have the limitation of direction and distance and must have a clear line of sight between transmitter and receiver. Therefore, the IR remote control has to aim at a specific A/V product within an effective range during operation. In other words, no physical obstruction can be in the path between the IR remote control and the specific product to block the IR signal. Therefore, a conventional IR remote control is not always convenient.

Many solutions have been developed to overcome the foregoing drawback of the IR remote control. With reference to FIGS. 5 and 6, a reflection device (70) was developed to overcome the fixed direction limitation. The reflection device (70) is mounted on the IR signal I/O port of an IR receiver and transmitter (80). The IR transmitter outputs an IR signal through the reflected device, and the IR signal will be reflected by the reflected device and then redirected to different directions, not only along the front direction of the IR signal transmitter. Inversely, the IR receiver can also receive an IR signal from the side direction not just from the front direction. Therefore, the IR receiver and transmitter almost completely omnidirectional and the conventional problem with fixed direction is virtually eliminated.

With the reference to FIG. 7, a solution for multiple devices (90, 91) respectively with IR transmitters (901, 910) provides an rf cable (92) with multiple IR/rf converters (93, 94) corresponding respectively to the IR transmitters (901, 910) in the devices (90, 91). The rf cable (92) with multiple IR/rf converters (93, 94) allow the devices (90, 91) to communicate with each other through the rf cable (92) at very long distances and completely out of the line of sight of each other. Consequently, a long rf cable (92) can solve the problems with the short transmitting range of IR signals and the line of sight limitation.

Although the foregoing solutions solve some of the drawbacks with IR remote control, they either do not solve all drawbacks or require a significant amount of fixed wiring.

IR remote control is used in most homes today in one form or another. Furthermore, the digital home to various degrees is starting to be more and more popular, such as the Home Network. The home network media is implemented with Ethernet, Home Plug, Home PNA, etc. The home network has provided the means to ordinary consumers to integrate and combine the capabilities of audio and video (A/V) products at home through the home network. The home network mainly controls the routing of A/V data. However, the combination does not provide the user the capability to control the functions of each A/V product by the IR remote control since the A/V product are normally in different rooms at home.

In addition the A/V products, the modern media servers are used to play and store the digital A/V data. The media server has the capability to store huge amounts of digitized A/V data and links to the network to allow users to access to the digital A/V data in the media server through network. The digital A/V data can then be played back on an A/V product at remote end such as in different rooms.

To make the network work as a complete carrier for home entertainment IR remote control signals should be digitized and transmitted as the A/V data to control the function of the A/V products and media server anywhere.

### SUMMARY OF THE INVENTION

The main objective of the invention is to provide a network device that combines IR remote control and audio and video signal transmission capabilities by converting IR signals to digital data for transmission on the network. Therefore, the network device interfaces the A/V products with the network.

Another objective of the invention is to provide a network device to interface A/V products and a media server with the network. The network device has a digital interface for connecting to the media server.

Other objectives, advantages and novel features of the invention will become more apparent from the following detailed description when taken in conjunction with the accompanying drawings.

### BRIEF DESCRIPTION OF THE DRAWINGS

FIG. 1 is a diagram of a network device, network media and multiple A/V products in different rooms;

FIG. 2 is a perspective view of the network devices in accordance with the present invention;

FIG. 3 is a functional block diagram of one embodiment of the network devices in accordance with the present invention;

FIG. 4 is a functional block diagram of another embodiment of the network device in accordance with the present invention;

FIG. 5 is a perspective view of a computer with an IR transmitter and a reflector in accordance with the prior art;

FIG. 6 is a side plan view of a conventional reflector in accordance with the prior art; and

FIG. 7 is a perspective view of two computers and an rf cable with multiple IR converters in accordance with the prior art.

### DETAILED DESCRIPTION OF THE PREFERRED EMBODIMENT

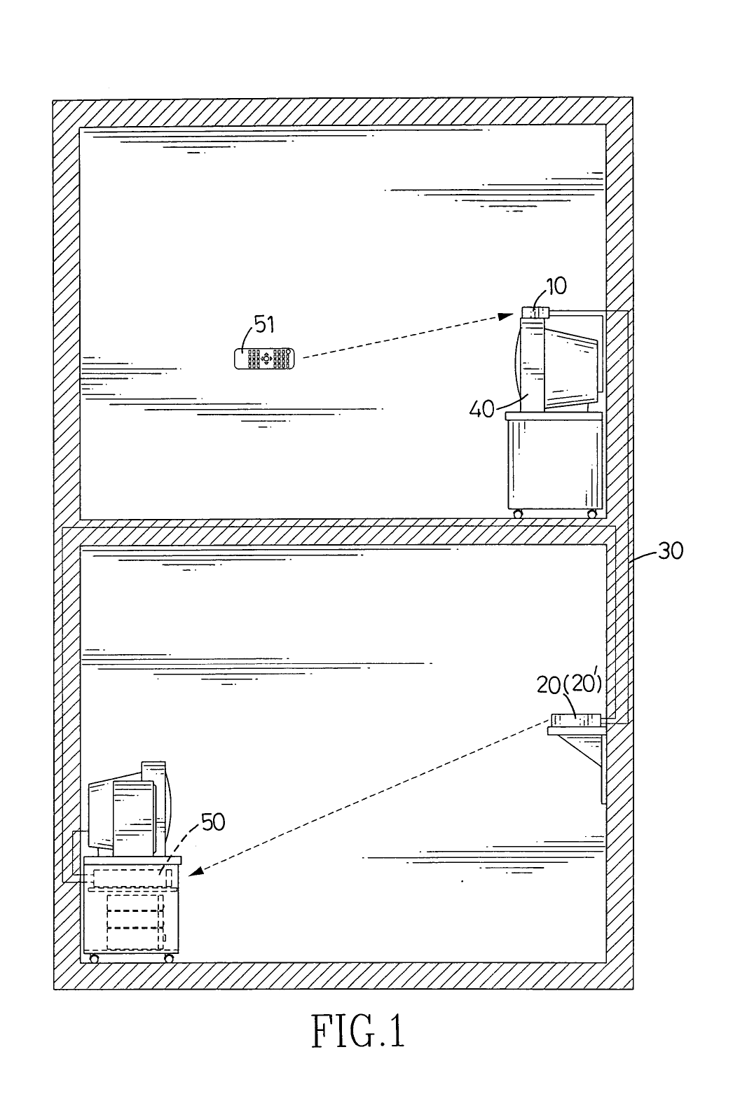

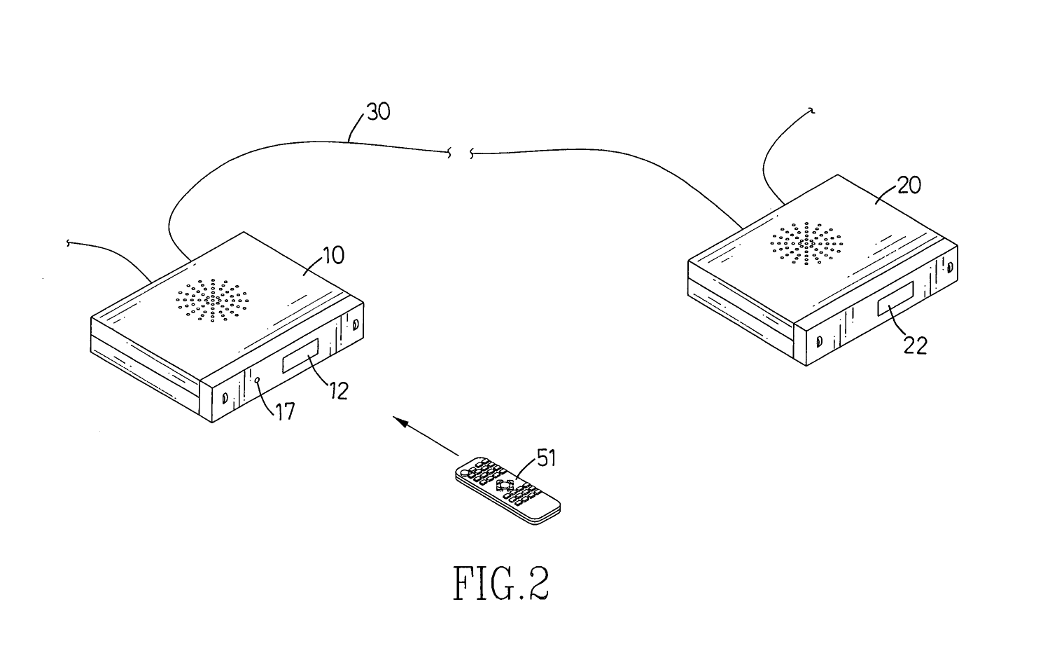

With reference to FIG. 2, a network device in accordance with the present invention includes a first network transmitter (10) and a second network transmitter (20). The first network transmitter (20) links to the second network transmitter (20) through network media (30) having network cables or wireless devices. With reference to FIG. 1, the first network transmitter (10) may be located in a room on second floor, and the second network transmitter (20) may be located in a room on first floor and corresponds to at least one A/V product such as an A/V player (50). In the setting, a person in the second floor room uses an IR remote controls (51) (52) for the A/V players (50) in the first floor room to remotely control the A/V player (50).

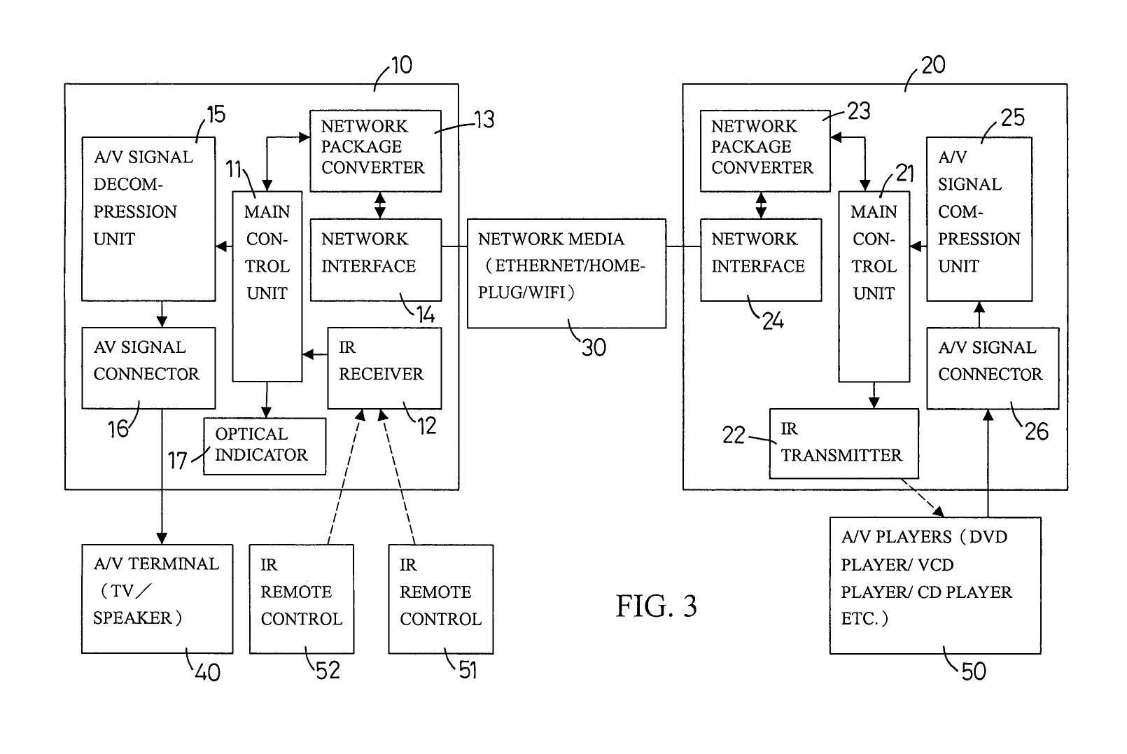

With reference to FIG. 3, the first network transmitter (10) has a main control unit (11), an IR receiver (12), a network package converter (13), an A/V signal decompression unit (15), an A/V signal connector (16), a network interface (14) and an optional optical indicator (17).

The main control unit (11) has multiple inputs and outputs and stores a first internet protocol (IP) address and a second IP address. The first IP address is a network position of the first network transmitter (10), and the second IP address is a network position of the second network transmitter (20). The IR receiver (12) is connected to an input of the main control unit (11) and outputs an electronic signal corresponding to a received IR signal to the main control unit (11) from IR remote controls. The A/V signal decompression unit (15) is connected between an output of the main control unit (11) and the A/V signal connector (16). The network interface (14) is connected to an input and output of the main control unit (11) through the network package converter (13) and is connected to the network media (30). The A/V signal decompression unit (15) decompresses (i.e. MPEG, decoding) a compressed A/V signal. The A/V signal connector (16) is connected to the A/V signal decompression unit and directly to an A/V product, such as a television or a speaker A/V terminal (40), etc. The A/V terminal (40) will play back the A/V signals from the A/V signal connector (16).

The second network transmitter (20) has a main control unit (21), an IR transmitter (22), a network package converter (23), a network interface (24), an A/V signal compression unit (25) and an A/V signal connector (26).

The main control unit (11) has multiple inputs and outputs and stores a first internet protocol address and a second IP address. The first IP address is the network position of the first network transmitter (10), and the second IP address is the network position of the second network transmitter (20). The IR transmitter (22) is connected to an output of the main control unit (21) and outputs IR signals to A/V players (50). The network interface (24) is connected to and input and output of the main control unit (21) through the network package converter (23) and is connected to the network media (30). The A/V signal compression unit (25) is connected to at least one A/V player (50) through the A/V signal connector (26) and is connected to an input of the main control unit (21). When the A/V player (50) outputs the A/V signal to the A/V signal compression unit (25) through the A/V signal connector (26), the A/V signal compression unit (25) will compress the A/V signal and output the compressed A/V signal to the main control unit (21). The main control unit (21) will output the compressed A/V signal to the network package converter (23) to be converted to network packages.

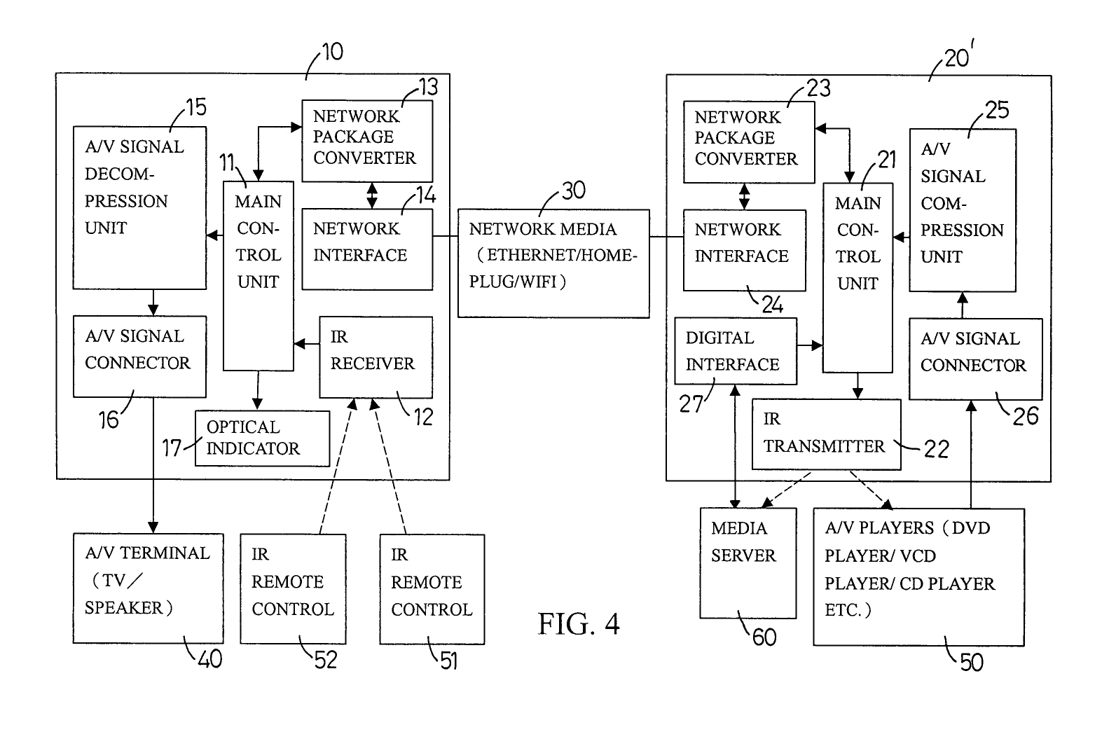

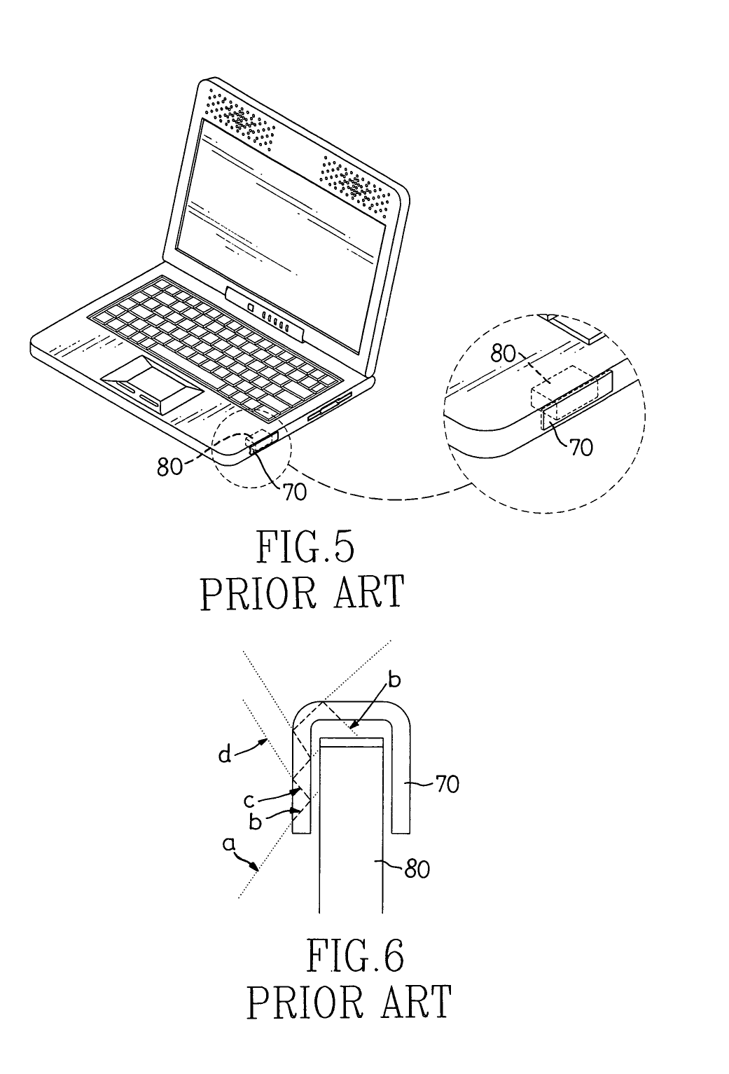

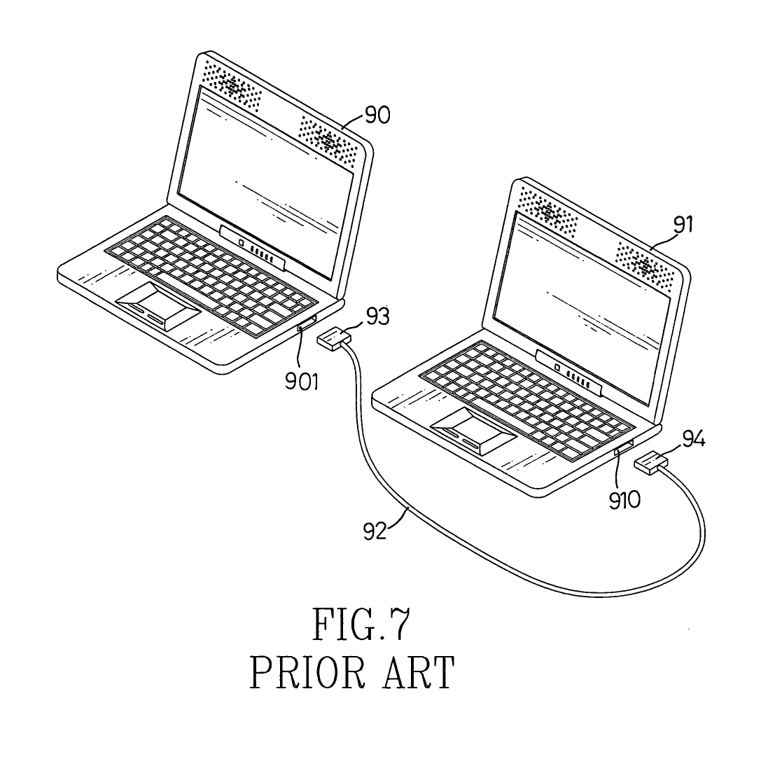

With reference to FIG. 4, the second network transmitter (20′) in a second embodiment of the network device has all the elements previously described in the second network transmitter (20) plus a digital interface (27) that is connected to a media server (60). The digital interface (27) is connected to an input and output of the main control unit (21) of the second network transmitter (20′). The IR transmitter (22) may send control signals to the media server (60).

With reference to FIGS. 1 and 4, a person operates an A/V player (50) or media server (60) remotely with an IR remote control (51) with an IR remote control (51) unique to the A/V player (50) or media server (60) to be controlled. When the A/V player (50) or media server (60) is set up in another room, a function bottom on the IR remote control (51) is pressed with the IR remote control (51) aimed at the IR receiver (12) of the first network transmitter (10). The IR remote control (51) will output an IR signal including a product identify code and a function code to the first network transmitter (10).

When the IR receiver (12) receives the IR signal from the IR remote control (51), the main control unit (11) will receive a corresponding electronic signal from the IR receiver (12) and then further obtains the product identify code and function code. The main control unit (11) simultaneously lights the indicator (17) to visually show an IR signal has been received by the first network transmitter. (10)

The main control unit (11) outputs the product code, the function code, the first IP address and the second IP address to the network package converter (13) to process the network command packages. The command packages will be sent to the second network transmitter (20′) through the network interface (14) connected to the common network media (30). Since the second network transmitter (20′) is also connected to the common network media (30) and the command packages include the second IP address, the second network transmitter (20′) will receive the command packages. The network package converter (23) will obtain the information in the command packages and provide the information to the main control unit (21). The main control unit (21) will output the product code and the function code to the IR transmitter (22). The IR transmitter (22) will convert them to an IR signal and further output the IR signal to control the specific function of the A/V player (50) or the media server (60). If the function code is a play A/V signal command, the A/V player (50) or media server (60) will output the A/V signals to the second network transmitter (20′). The A/V signal compression unit (25) will first compress the A/V signals and output the compressed A/V signal to the main control unit (21). The main control unit (21) outputs the compressed A/V signal to the network package converter (23) to process them to network packages. The network package converter (23) will outputs the network packages including the compressed A/V signal and the first and second IP addresses to the network media (30) through the network interface (24). Therefore, the first network transmitter (10) will receive the network packages from the network media (30). The network package converter (13) of the first network transmitter (10) will obtain the compressed A/V signals from the network packages and then output them to the main control unit (11). The main control unit (11) will output them to the A/V signal decompression unit (15). The A/V signal decompression unit (15) decompresses the compressed A/V signals to A/V signals and outputs the A/V signals to the A/V signal connector (16). The A/V terminal (40) will obtain the A/V signals from the A/V player (50) or media server (60) through the present invention to display and/or broadcast. Therefore, a person can remotely control A/V players or the media sever in different places.

As more and more houses are built with the home network, a network device having infrared IR remote control and audio and video signal transmitting capabilities in accordance with the present invention will be able to utilize the home network to integrate A/V products and even the media server together. Since the present invention converts IR signals, the IR remote controls of all A/V products could be used easier and have a virtually unlimited control range. In addition, the control signal is not restricted by optical obstructions when controlling the A/V products.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A network device having IR remote control and audio and video signal transmitting capabilities, comprising:
a first network transmitter connected to at least one A/V terminal and a network media and having a capability to convert IR signals to network packages; and
a second network transmitter connected to at least one A/V player and the network media, linked to the first network transmitter and having a capability to convert corresponding network packages to IR signals.

2. The network device as claimed in claim 1, wherein the first network transmitter comprises:
a main control unit having multiple inputs and outputs and storing a first IP address being a network position of the first network transmitter and a second address being a network position of a second network transmitter;
an IR receiver connected to an input of the main control unit and receiving IR signals from IR remote controls of A/V products;
an A/V signal decompression unit connected to the output of the main control unit to output A/V signals;
an A/V signal connector connected to the A/V signal decompression unit and to an A/V terminal;
a network package converter bi-directionally connected to the main control unit; and
a network interface connected to the network package converter and the network media.

3. The network device as claimed in claim 2, wherein the first network transmitter further comprises an indicator connected to the main control unit to indicate that the main controller unit has been received an IR signal from the IR remote control through the IR receiver.

4. The network device as claimed in claim 1, wherein the second network transmitter comprises:
a main control unit having multiple inputs and outputs and storing a first IP address being the network position of the first network transmitter and a second IP address being the network position of the second network transmitter;
an IR transmitter connected to an output of the main control unit to output IR signals to A/V players;
an A/V signal compression unit connected to an input of the main control unit to output compressed A/V signals;
an A/V signal connector connected to the A/V signal compression unit and to at least one A/V player and outputs A/V signals from the at least one A/V player to the A/V signal compression unit;
a network package converter connected to an input and an output of the main control unit; and
a network interface connected to the network package converter and to the network media.

5. The network device as claimed in claim 4, wherein the second network transmitter further comprises a digital interface connected to at least one media server storing A/V data.

6. The network device as claimed in claim 2, wherein the second network transmitter comprises:
a main control unit having multiple inputs and outputs and storing the first IP address being the network position of the first network transmitter and a second IP address being the network position of the second network transmitter;
an IR transmitter connected to an output of the main control unit to output IR signals to A/V products;
an A/V signal compression unit connected to an input of the main control unit to output compressed A/V signals;
an A/V signal connector connected to the A/V signal compression unit and to at least one A/V player and outputs A/V signals from the at least one A/V player to the A/V signal compression unit;
a network package converter connected to an input and an output of the main control unit; and
a network interface connected to the network package converter and to the network media.

7. The network device as claimed in claim 6, wherein the second network transmitter further comprises a digital interface connected to at least one media server storing A/V data.

8. The network device as claimed in claim 1, wherein the network media consists of network cables.

9. The network device as claimed in claim 1, wherein the network is consisted of wireless devices.
